(19) United States
(12) Patent Application Publication
(10) Pub. No.: US 2005/0036323 A1
(43) Pub. Date: Feb. 17, 2005

(54) Method and apparatus for the housing of network elements

(75) Inventor: Nicolaius Henricus Gerardus Baken, Voorburg (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Koninklijke KPN N.V., Groningen (NL)

(21) Appl. No.: 10/881,715

(22) Filed: Jun. 29, 2004

Related U.S. Application Data
(60) Provisional application No. 60/484,199, filed on Jul. 1, 2003.

(30) Foreign Application Priority Data
Dec. 29, 2003 (EP) 03079012.5
Apr. 2, 2004 (EP) 04076055.5

(51) Int. Cl. F21S 2/00

(52) U.S. Cl. 362/382

(57) ABSTRACT

It is disclosed that a public facility (1) such a lamppost (30) can be used to contain active- and passive network elements of a communications network (3). The network elements may be part of an access infrastructure of communications network (3), or may be part of a core network. A lamppost (30) is disclosed that can contain active and passive network elements. It is also disclosed how to supply power to the network elements contained by the lamppost (30).

### CROSS REFERENCE TO RELATED CASES

The present patent application claims priority under 35 U.S.C. Sectin 119 (e) from a U.S. Provisional Patent Application Ser. No. 60/484,199, filed on Jul. 1, 2003 (MBHB Docket No. 03-686), which is herein entirely incorporated by reference and to which the reader is directed to for futher information. The present patent application is also related to European Patent Application No. 03079012.5, filed on Dec. 29, 2003; and European Patent Application No. 040760055.5, filed on Apr. 2, 2004; which are herein entirely incorporated by reference and to which the reader is directed to for futher information.

### FIELD OF THE INVENTION

The present invention generally relates to a concept for the use of public facilities such as lampposts for containing active and/or passive elements of a telecommunication infrastructure, and an apparatus for containing active and/or passive elements of a telecommunication infrastructure.

### BACKGROUND OF THE INVENTION

There is an increasing demand for new telecommunication services, in particular services that offer high-speed data transmission (e.g. for video), cordless access (e.g. customer premises networks) and mobile roaming. To offer these services, it is needed to install active and passive telecommunication equipment that is part of a network, which network may comprise a core networks and an access network. If the active and passive telecommunication equipment is to be installed outside a centrally located telecommunication center (such as a telephony exchange), problems may arise due to a lack of space that is needed to contain this equipment. For instance, for broadband services it can be required to install equipment on public domain (e.g. in a residential quarter).

Concentration points should then be available to install the telecommunication equipment in. For instance in the case of a glass fibre network, glass fibre cables are installed in ducts (tubes). Due to the high volume of these ducts, it is generally impractical to provide each end-user with a separate duct to the core network access point (e.g. telephone exchange building). Hence, the broadband access network will contain concentration points. These concentration points may contain passive (e.g. a ‘Y-coupling’) and/or active (e.g. optical hardware) equipment.

However, there is not always space available to install a concentration point. Also, there has to be permission from some type of a government body or authority in question for installing the concentration point on or in public ground. Further it can be expensive, time-consuming and sometimes extremely difficult to install a concentration point. For instance, if the existing situation is complex (e.g. due to existing cables and other infrastructure) it may be cost prohibitive to install a concentration point. Another potential drawback is that a dedicated power supply should be installed on behalf of the telecommunication equipment to be installed in a concentration point. Another potential concern relating to typical equipment installations is that the equipment installed in a concentration point is not easily accessible if the concentration point is situated in the ground.

There is, therefore, a general need to eliminate the drawbacks of such typical systems and to provide an efficient concept for the housing of active and passive network elements of communication networks.

### SUMMARY OF THE INVENTION

In accordance with one aspect of the present invention, a concept and an apparatus are disclosed for the housing of active and passive network elements of a communication network. For this purpose, the concept according to the present invention comprises:

Usage of a public facility for containing a network element of a communications network.

In a first aspect of the invention a concept is disclosed in which public facilities such as lampposts can be used for containing active and/or passive elements of a telecommunication infrastructure. If the public facility is a lamppost, it is possible to house the telecommunication equipment because lampposts are hollow, and because electrical power can be made available in a lamppost and/or its feeding network. Using these characteristics of lamppost, the amount of digging activities is reduced when installing telecommunication infrastructure in and on public ground. The invention is not limited to lampposts. Other types of public facilities and installations, such as traffic lights, can also be used in a way described in this disclosure. As one is can understand, the invention does not exclude private facilities if these facilities have the same characteristics as the public facilities have that are discussed in this disclosure.

In the context of this application facilities are regarded which are part of a utility infrastructure, such as a electricity supply, a lighting infrastructure, a telecommunication infrastructure or an infrastructure for gas supply. If there is space available in such a facility (e.g. a lamppost, a road sign, a bridge construction, or a traffic-light), then the facility can be used for the housing of active and/or passive elements of a telecommunications infrastructure. For the present invention it is of little or no relevance who owns the facility, it may be public or private property. Sometimes facilities are known as public facilities while in fact they are private facilities. It may also be the case that a facility first was public property after which it became private property. However, all of these issues are of little or no relevance for the present invention.

In general, the housing of active and/or passive elements of a telecommunications infrastructure in a facility can be especially advantageous if the facility is near a customer premise such as a house or a public or private office. In such a situation it may be possible to have the active and/or passive elements located on a relatively short distance from the end-user facilities on the customer premise. It may also be advantageous if there is already a power-supply available in the facility. This power supply can then be used for the elements housed by the facility. It may be clear however, that an existing power-supply in a facility is not mandatory. For instance, it may also be possible to use a curbstone for the housing of active elements after space has been created inside the curbstone as a result of the removal of curbstone material.

The network elements that can be contained by public facilities may be part of an access infrastructure that connects user domains to a communications network. It is also possible that the network elements contained by public facilities are not part of an access infrastructure. In this case the network elements are part of another part of the communications network.

The communications network can be a broadband network such as VDSL or a fiber-to-the-home (FTTH) network. For example, a concept in the Netherlands for fibre-to-the-home (FTTH) is ‘Tri-Net’. Tri-net uses cabinets as access network nodes on a ‘per suburb’ level. From these cabinets, rather wide ducts (40-50 mm) run towards rows of houses. In front of each house, a ‘Y coupling’ is being used to branch micro-ducts the customer's premises. The micro-ducts may contain copper and/or glass fibre cables. At the node, a rather large volume of soil is taken up by the ducts and the cable lengths to the concentration points are rather long, resulting in high fibre costs. The node's cabinets are rather large and their allocation is sometimes troublesome, as they need the city council's consent.

The present invention is not limited to the application in broadband networks. It may also be possible to apply the invention for other types of communications networks. The communications network may also be a mobile network, or a network comprising mobile and fixed elements and technologies. There are no limitations to the technologies used in the communications network. The communications network may also comprise optical technologies. Also the topology of the communications network is no constraint for applying the present invention. For instance, the communications network may have a meshed- or a star-topology. The communications network may also be an ad-hoc network, i.e. a network that is dynamically configured. Further, the communications network may also be a local network such as a wireless LAN or any other local network that can be used by users in a (relative) vicinity to the local network.

Another aspect of the invention relates to the concept in which the public facilities and installations can be used in relation to the communications network, e.g. for security purposes. In such a case, the public facility is used to contain a video camera. The purpose of a video camera is then to monitor human activities around the public facility, e.g. for security purposes.

In yet another aspect of the invention a system is disclosed that can be used as a public facility or installation, and that can contain active and passive network elements of a communications network. These network elements may or may not be part of an access infrastructure that connects user domains to a communications network.

According to this invention also a public facility such as a lamppost is disclosed that can contain network elements of a communications network. In the case of a lamppost, the lamppost comprises a number of features that facilitate the usage of the lamppost for this purpose such as a power supply facility, an access panel and fastening facilities.

Further, it is disclosed how to supply power to the equipment that is installed in public facilities such as lampposts. In a lamppost electrical power is already available, although not necessarily all the time. Solutions to overcome this include:
1. to provide continuous supply from a power station via an unswitched extra power line (this will not be a problem in greenfield situations);
2. to use batteries, solar cells or solar cells combined with batteries;
3. biased feed of e.g. direct current from the power station, over a power line to ground (phantom feed);
4. biased feed of low voltage below the ignition voltages of plasma lamps;
5. biased feed of low voltage (e.g. for filament lamps) with switching off the power to the lamp by the electronic power supply.

### BRIEF DESCRIPTION OF THE FIGURES

The foregoing aspects and many of attendant advantages of this invention will become better understood by reference to the following detailed description, when taken in conjunction with the accompanying drawing, wherein:

FIG. 1 is a block diagram illustrating the concept of using a public facility (1) for containing active and passive network elements of a communications network (3).

FIG. 2 shows a regular lamppost (30).

In FIG. 3 a lamppost (30) is depicted that is adapted in such a way that it is suitable for containing telecommunication equipment (11).

In FIG. 4 and FIG. 5 details of a lamppost are depicted in relation to the access of telecommunication (11) that is contained in a lamppost.

FIG. 6 shows an advantageous embodiment of the lamppost (30) is depicted when the telecom equipment (11) may be packaged in a sealed cocoon (14).

In FIGS. 7, 8, 9 and 10 the power concept is depicted.

### EXEMPLARY EMBODIMENTS

For the purpose of teaching of the invention, preferred embodiments of the method and devices of the invention are described in the sequel. It will be apparent to the person skilled in the art that other alternative and equivalent embodiments of the invention can be conceived and reduced to practice without departing form the true spirit of the invention, the scope of the invention being limited only by the appended claims as finally granted.
In one arrangement, the invention comprises:
   The concept of integrating network nodes, e.g. in lampposts
   The concrete (physical, mechanic, electrical, opto-electronic and radio) design of lampposts to serve as combined network nodes. This part of the invention includes adaptation of existing lampposts and other public facilities as well as the design of new specialised products.

This invention creates a possibility for having low cost concentration points close to the end-points, thus amongst others overcoming the soil volume problem.

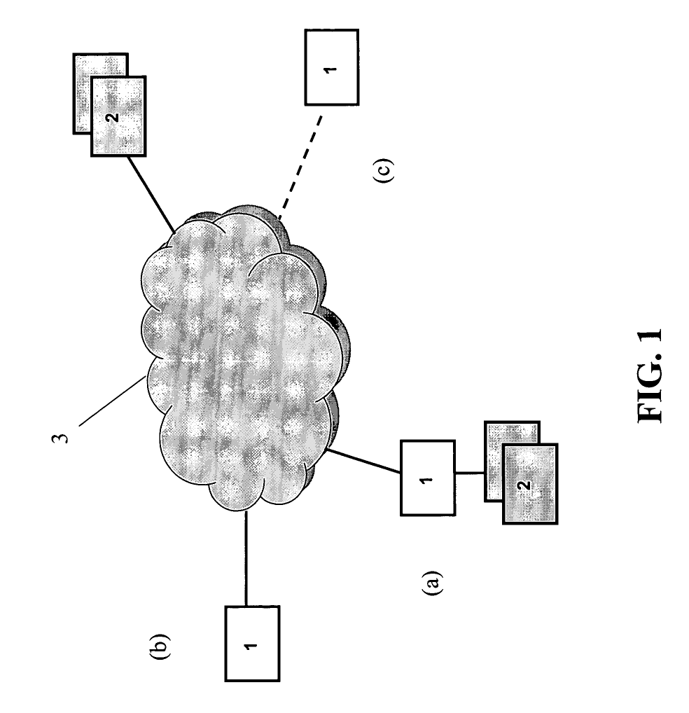

FIG. 1 shows a conceptual picture of the invention. A communications network (3), that can be a telecommunication or data-communication network, may comprise core-network infrastructure and access infrastructure, both not being depicted in FIG. 1. The communications network (3) consists of network elements (not depicted in FIG. 1), such as network devices and network connections. The techniques used in these network elements can be based on wired- and/or wireless techniques. The communications network can be amongst others a broadband network (e.g. VDSL, FTHH).

The network elements that are part of communications network (3) may comprise hardware-, firmware-, and software elements. The variety of possible network elements is very diverse. There can be active-, non-active-, optical- and non-optical network elements in the communications network (3). Network elements also comprise network connections such as copper cables, (optical ) fibers and related passive- and active equipment, such as multiplexers, cable splitters, etc.

Further, the communications network (3) can be a fixed network, a mobile network or a network where both types of communication are accommodated. The communications network (3) can be a public or a private network, or a combination of a public network and a private network. The communications network (3) can be operated by one network operator. It is also possible that the communications network (3) is operated by different network operators and/or service operators. In the latter, each network operator operates its own network domain, where a domain may be determined by geographical, functional or logical parameters.

A user domain (2) can be connected to the communications network (3). The user domain (2) comprises telecommunication equipment and data-communication equipment of a user that uses the services that are provided via the communications network (3), such as a telephone, a mobile telephone, a computer and a fax. The user domain (2) may also comprise a local network, which can be the case for corporate users although consumers can have a local network too. The local network may also be a network that can be used as a public network by other users. The connection between a user domain (2) and a communications network (3) is often called a local-loop.

According to the invention, in a public facility (1) active-, non-active, optical-, and non-optical network elements of a communications network (3) can be placed inside the public facility (1). In addition or optionally it can be possible that facilities originally available for the public facility (1), such as power supplies, are used by or shared with these network elements. The connection between the network elements in the public facility (1) and the communications network (3) can be based on wired and/or wireless technology. For example, it is possible to have a bundle of optical fibers between a local exchange and a public facility (1), in which case the public facility (1) acts as a cabinet in which active components reside for supporting the optical connections. Since the public facility (1) can physically be close to the user domains (2), individual fibres per home or office can have a minimum length instead of running all the way from the last local exchange towards the home or office. This is depicted in FIG. 1 with option (a). The connection between the public facility (1) and the user domains (2) can be based on wired- and wireless technology. The invention also comprises the situation where network elements are placed under the public facility (1) instead of in the public facility (1).

In another embodiment of the invention, the public facility (1) can be connected to the communications network (3), without user domains (2) being connected to the public facility (1). In this embodiment, depicted in FIG. 1 with option (b), the public facility (1) can be seen as a sort of network node that contains network elements that are part of communications network (3). If the public facility (1) is not connected to the user domains (2) it is also possible that the public facility (1) itself acts as a network element of communications network (3), for example if the public facility (2) is used as an antenna.

According to this invention it is also possible that the public facility (1) is not connected to the communications network (3), but is used in relation to communications network (3). This is depicted in FIG. 1 with option (c). This is for example the case if a video camera is placed in or upon the public facility (1) in relation to the security of (parts of) the communications network (3).

Because the techniques used in the network elements of the communications network (3) can be based on wired- and/or wireless techniques, the network connection between the network elements in the lamppost and the user domain (2) can be wired or wireless. In the wireless situation it can be for example a wireless local area network (WLAN) that is supported by the network elements in the lamppost. In the wired situation it can be for example a VDSL environment that is supported.

The invention is not limited to public facilities. Other types of public facilities and installations, such as traffic lights, can also be used in a way described in this disclosure.

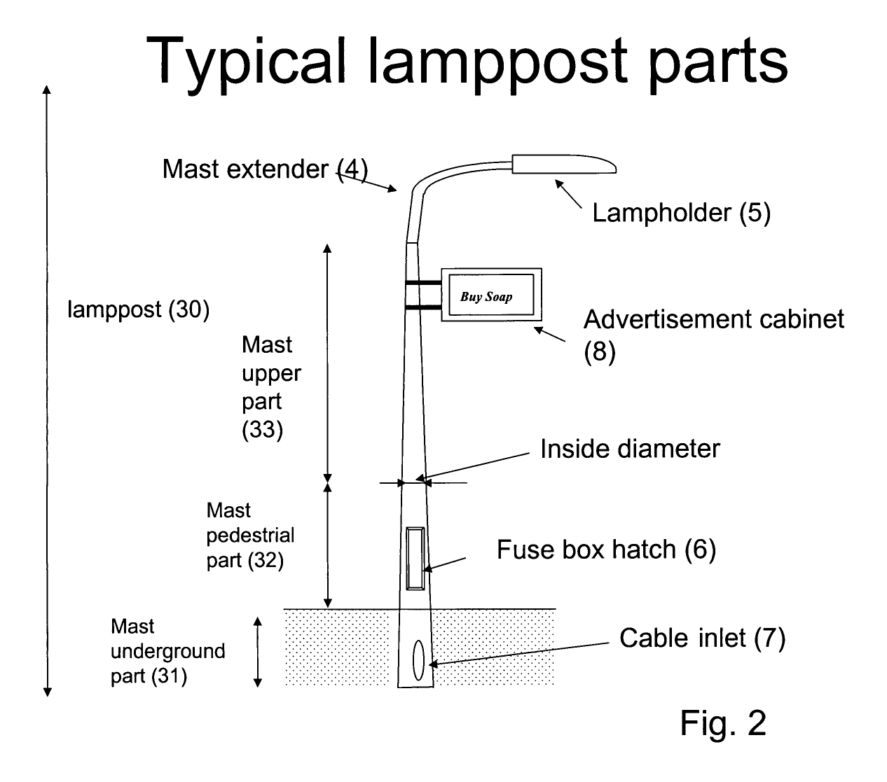

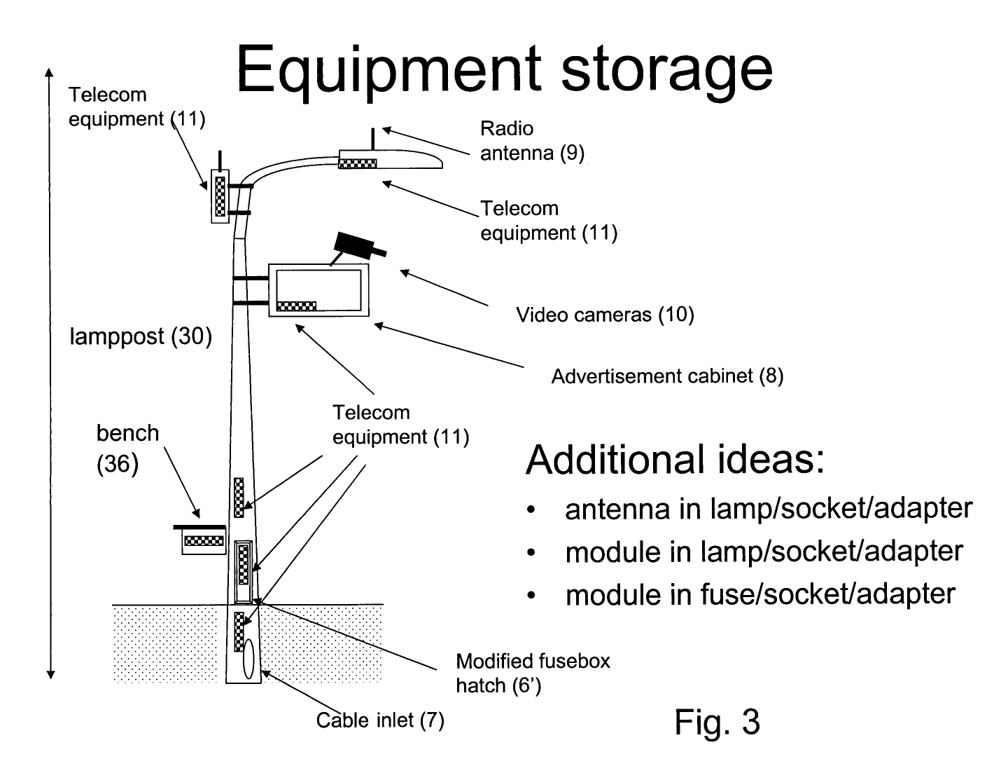

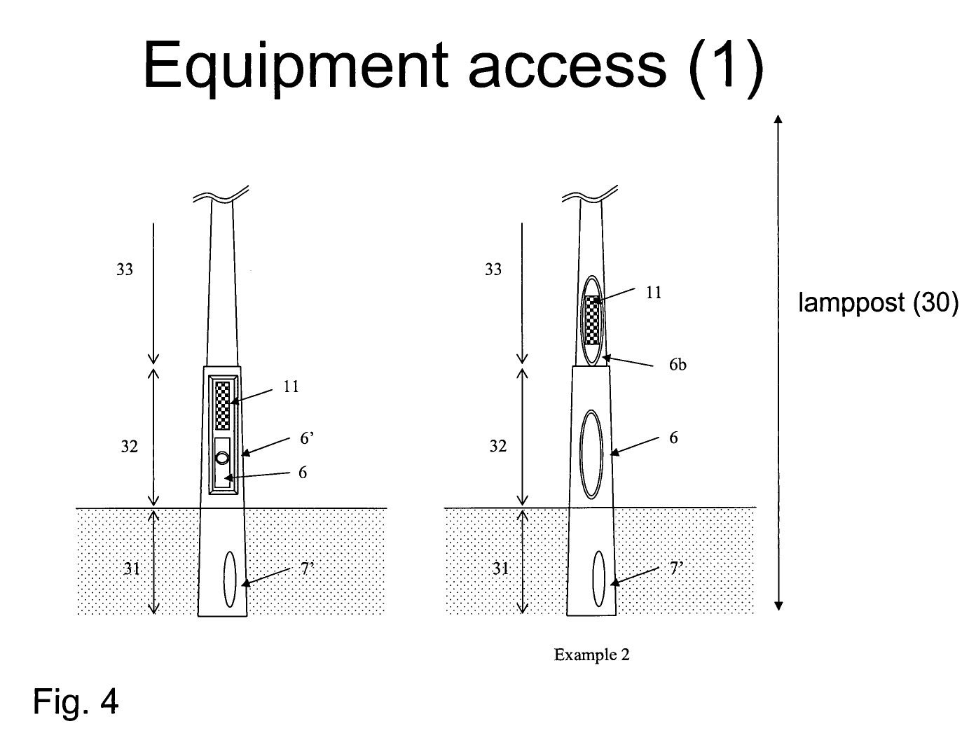

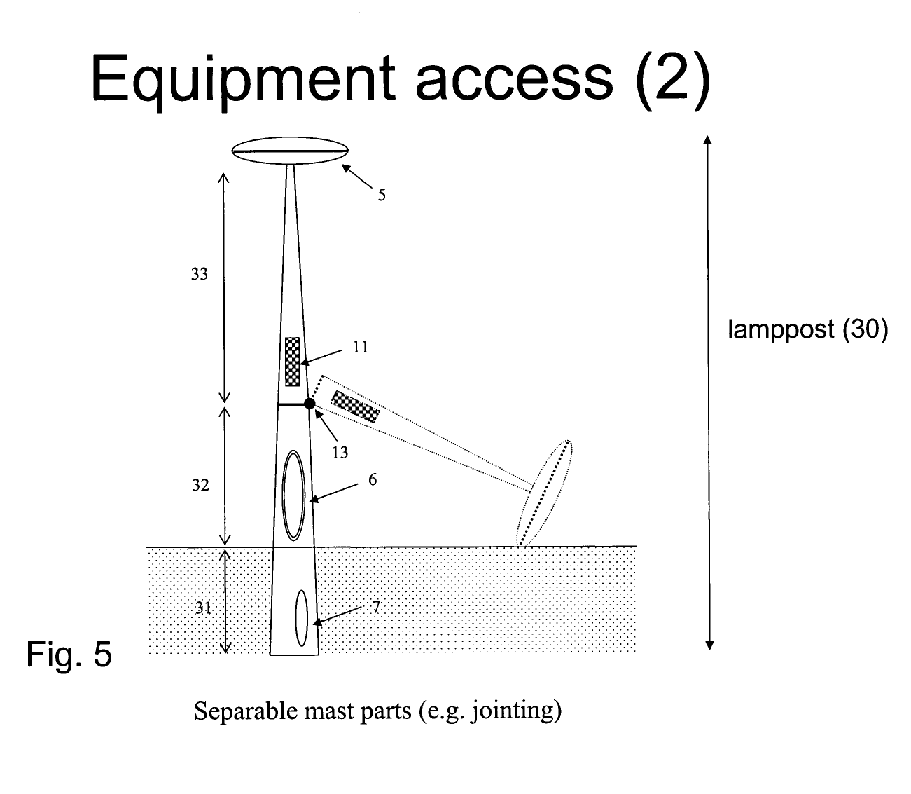

In FIG. 2 a lamppost (30) is depicted that is used for its primary function, i.e. in general to support lights at some level above the street. A lamppost (30) may comprise different construction parts such as a mast underground (31), a mast pedestal part (32), a mast upper part (33), and a mast extension part (4). A lamp holder (5) that comprises a lamp (not shown in the figure) can be connected to the extension part (4). Cables for power supply purposes enter the lamppost (30) through a cable inlet (7). Access to the interior of the lamppost (30) can be done via a fuse box hatch (6), for instance for maintenance purposes such as the replacement of fuses. In some cases, there can be an advertisement cabinet (8) attached to the lamppost (30).

FIG. 3 shows a lamppost (30) that facilitates the containing telecom equipment (11). The lamppost (30) can be an existing lamppost where the existing lamppost is, beside its regular use, suitable for containing telecom equipment (11). The lamppost (30) can also be designed for the purpose to contain telecom equipment (11). A lamppost (30) according to FIG. 3 is an integrated service and network node.

The telecom equipment (11) can be any (combination of) network element(s) of a communications network (3). Telecom equipment (11) can be located at different positions inside or attached to the lamppost (30). For instance, the telecom equipment can be located inside the lamppost (30) near a modified fuse box hatch (6′), i.e. the fuse box hatch (6) that has been modified for the purpose of installing, maintaining or removing telecom equipment (11) inside the lamppost (30). For a proper operation of the telecom equipment a cable inlet (7) can be used for wiring purposes. It is also possible to have attached telecom equipment (11) to the exterior of the lamppost (30). For example the telecom equipment can be contained in the advertisement cabinet (8), or a video camera (10) can be attached to the lamppost (30).

According to an embodiment of the present invention, lampposts may be designed with the combined purpose to support lights or camera's at some level, but also to offer space for equipment. For this purpose, the lower part of the lamppost (30) may have a specific shape (e.g. be wider) and may have specific facilities to access the equipment. These access facilities may be wide hatches offering radial access, but also axial access e.g. by making the upper part of the lamp post detachable (e.g. by hinges). Specific realisations may be contrived for specific purposes, taking into account the requirements for the combined functionality of the lamppost (30) and taking aesthetic demands into account. Creative solutions may be found, e.g. by using the lower part of the lamppost (30) as a kind of bench. According to the present invention the space inside a lamppost (30) can be used advantageously taking into account that integrated optics and IOC's (in-house optical circuits) are on the verge of breaking through leading to smaller passive and active optical components and circuits. Another development, which makes the present invention advantageously, is that local authorities are reluctant to digging up of streets and this is not necessary anymore. Further, electrical power is available in every lamppost (30) and easy but safe access to the telecom equipment (11) can be organised. Also redundancy can be organised, since in general there more than one lamppost (30) in a relative small area.

Using a lamppost (30) according the present invention may enable the handling of fibres in and or below the lamppost (30). Another application according the present invention may be the use of mechanical fibre splices and IOC's to offer connectivity to individual homes. It may also be possible to design the lamppost (30) such that it can act as an antenna, e.g. for WIFI pico cells for wireless and mobile ICT applications such as Blue tooth. For broadcast television an antenna (9) could be mounted on or in the lamppost (30), which antenna can be used for the wirelessly transmission of signals from the lamppost (30) to equipment on the end-user's location. It is also possible, for instance for the purpose of broadcast television, that an antenna is mounted on or in the lamppost (30), which antenna receives signals that are transmitted from the antenna to the end-user's equipment via an infrastructure between the lamppost (30) and location of the end-user. The transmission between the lamppost (30) and the location of the end-user can be via a wired infrastructure such as fibres or copper, or can be wireless.

It may also be possible to install cache servers and IAD's (integrated access devices) inside a lamppost (30) to provide a number of homes with tailored information regarding all kind of applications.

Camera's (10) for all kind of purposes may be contained by the lamppost (30). It is also possible that the lamppost (30) contains road signs, which road signs are holograms. Further it is also possible that the lamppost (30) contains screens that can be rolled up. Camera's, hologram road signs, screens and the like can be mounted on or in the lamppost (30). Any electrical signal to or from the camera, road sign or screen can be supplied or received via the lamppost (30).

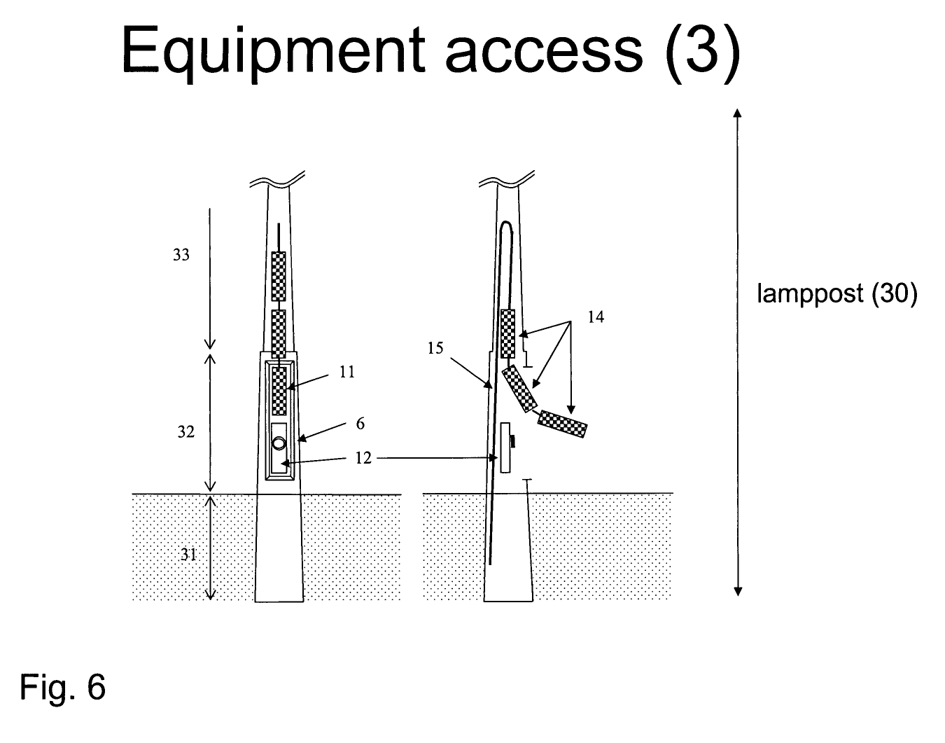

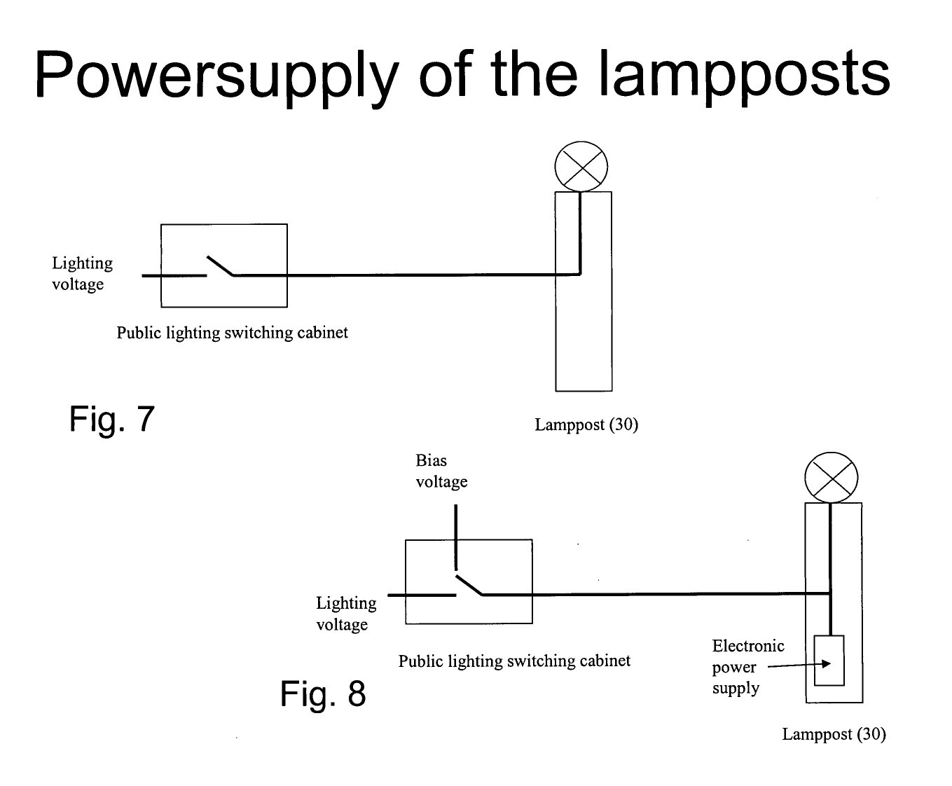

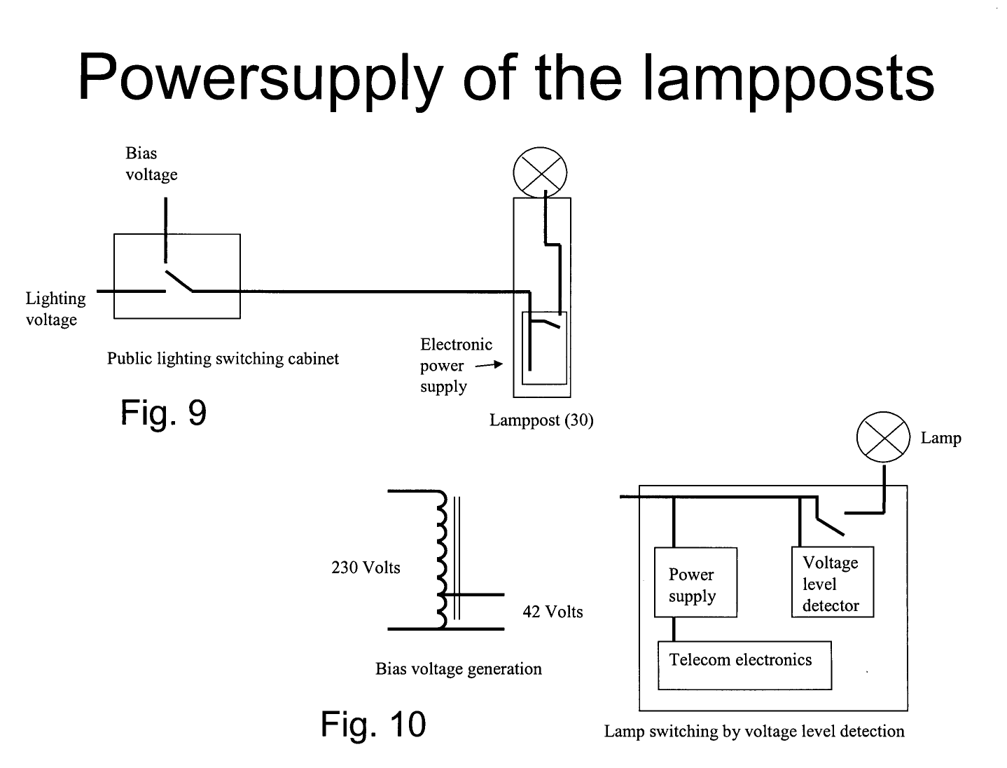

The access to the telecom equipment (11) can be through the modified fuse box hatch (6′) as is depicted in FIG. 4. An embodiment of the modified fuse box hatch (6′) comprises an enlarged original fuse box hatch (6). Another embodiment comprises a separate fuse box hatch (6b). Another concept for accessing the telecom equipment (11) is shown in FIG. 5. In this embodiment the lamppost (30) is provided with a hinge (13), enabling the mast upper part (33) so that telecom equipment (11) is made accessible. In FIG. 6 an advantageous embodiment of the lamppost (30) is depicted when the telecom equipment (11) may be packaged in a sealed cocoon (14). The cocoon (14) may be slided downwards or upwards. In case more equipment space is needed, several cocoons (14) may be concatenated (e.g. power supply and transmission module). A telecom cable (15) may be connected to one or more cocoons (14).

FIG. 7. depicts an existing situation. The lamppost (30) is provided with electricity with branched cables originating from a power distribution street cabinet. This cabinet contains distribution fuses and relays. The lamppost (30) will be switched on by relay that respond to tone-frequent signals over the power network. In some cases additionally twilight detection is being used.

Using public facilities such as lampposts for the housing of telecom equipment (11) will in most cases offer the benefit of having electrical power already available. Since this power may not always be continuously available, a possible solution to overcome this is to provide continuous feed from a power station via an unswitched extra power line (e.g. in greenfield situations). It may also be possible to use batteries, solar cells or solar cells in combination with batteries, or to use a rechargeable battery. Biased feed of e.g. direct current from the power station, over a power line to ground (phantom feed) may also be used.

Biased feed of low voltage below the ignition voltages of plasma lamps may also be an option, this is depicted in FIG. 8. FIG. 8 illustrates the possibility to provide continuous power to electronic devices in lampposts, by having the relay in the power cabinet alternate between full voltage (e.g. 230 Volts AC) and bias voltage (e.g. 42 Volts AC). Generally, lamps in lamppost are of the ‘plasma’ type. The gas in such lamps generally does not ignite below 100 Volts. Therefore, the bias voltage of 42 Volts will not cause these lights to ignite and will not draw a current from the bias feed. Electronic power supplies for telecom equipment can easily be designed to operate from 230 Volts as well as from 42 Volts, thus providing a continuous power supply.

Biased feed of low voltage (e.g. for filament lamps) with switching off the power to the lamp by the electronic power supply is also an option, this is depicted in FIG. 9 and FIG. 10. FIG. 9. illustrates a variant to the bias feed, specifically for filiament type of lamps, which would still draw current form a low bias voltage. In this case, the electronic power supply in the lamppost could be equipped with an extra function (e.g. voltage sensor and a relay) that will switch off the lamp during low voltage bias feed. FIG. 10. shows sample implementation details in relation to the solution that is depicted in FIG. 9.

In view of the wide variety of embodiments to which the principles of the invention can be applied, it should be understood that the illustrated embodiment is exemplary only, and should not be taken as limiting the scope of the present invention. For example, one of ordinary skill in the art will readily appreciate that various elements of the present invention can be practiced with software, hardware, or a combination thereof.

The claims should not be read as limited to the described order or elements unless stated to that effect. Therefore, all embodiments that come within the scope and spirit of the following claims and equivalents thereto are claimed as the invention.

1. Usage of a public facility (1) for containing a network element of a communications network (3).

2. Usage according to claim 1, whereby the public facility (1) is a lamppost (30).

3. Usage according to claim 1 or 2, whereby said network element is an active or passive network element.

4. Usage according to claim 1, 2 or 3, whereby said network element is part of an access infrastructure of the communications network (3).

5. Usage according to claim 1, 2, 3 or 4, whereby said network element is an antenna that is used for receiving signals, which signals are to be further distributed to end-user's equipment.

6. Usage of a lamppost (30) for containing a camera, a screen or a road sign whereby said camera, screen or road sign is mounted on or in the lamppost (30).

7. A public facility (1) fit to contain a network element of a communications network (3).

8. A public facility (1) according to claim 7, whereby the public facility (1) is a lamppost (30).

9. A lamppost (30) according to claim 8, whereby said network element is an active or passive network element.

10. A lamppost (30) according to claim 8 or 9, whereby said network element is part of an access infrastructure of the communications network (3).

11. A lamppost (30) according to claim 8, 9 or 10, whereby the network element is an antenna that is used for receiving signals, which signals are further distributed to end-user's equipment.

12. A lamppost (30) fit to contain a camera, a screen or a road sign whereby said camera, screen or road sign is mounted on or in the lamppost (30).

13. A lamppost (30) according to claim 8, 9, 10 or 11, the lamppost (30) comprising:
a power supply facility in behalf of said network element
an access panel
facilities for fastening said network element

14. A lamppost (30) according to claim 13, whereby the power supply is fed by a voltage, which voltage is below the ignition level of a lamp in the lamppost (30).

15. A lamppost (30) according to claim 13, whereby the power supply facility is a rechargeable battery.

16. A lamppost (30) according to claim 13, whereby the lamppost (30) comprises a facility that prevents the supply of said voltage to a lamp in the lamppost (30).

17. Method for adapting a lamppost (30) in order to make the lamppost (30) suitable for containing a network element of a communications network (3).
